(19) United States
(12) Patent Application Publication
(10) Pub. No.: US 2014/0113211 A1
(43) Pub. Date: Apr. 24, 2014

(54) TAYLOR VORTEX FLOW FUEL CELLS UTILIZING ELECTROLYTE SUSPENSIONS

(71) Applicant: GLOBAL ENERGY SCIENCE, LLC (A CALIFORNIA LIMITED LIABILITY COMPANY), Santa Barbara, CA (US)

(72) Inventor: HALBERT FISCHEL, SANTA BARBARA, CA (US)

(73) Assignee: GLOBAL ENERGY SCIENCE, LLC (A CALIFORNIA LIMITED LIABILITY COMPANY), Santa Barbara, CA (US)

(21) Appl. No.: 14/054,969

(22) Filed: Oct. 16, 2013

Related U.S. Application Data
(63) Continuation-in-part of application No. 13/789,844, filed on Mar. 8, 2013.
(60) Provisional application No. 61/717,589, filed on Oct. 23, 2012.

(51) Int. Cl. H01M 8/04; H01M 2/38

(52) U.S. Cl. CPC H01M 8/04291; H01M 2/38
USPC 429/451

(57) ABSTRACT

Taylor Vortex Flow fuel cells (102) for converting chemical energy into electrical energy and comprising a cylindrical rotating particulate filter (120) between cylindrical current collectors (106, 108) for use with electrolytes containing charged galvanic material particles that flow between the cylindrical current collectors (106, 108) and the filter (120) are disclosed.

### CROSS-REFERENCE TO RELATED APPLICATIONS

This application is a continuation-in-part of my U.S. patent application Ser. No. 13/789,844 filed 8 Mar. 2013 that claims the benefit of U.S. Provisional Patent Application Ser. No. 61/717,589 of 23 Oct. 2012—both incorporated herein by reference in their entirety.

This application, identified as Case I, is related to the following patent applications of Halbert P. Fischel:
Case A: Electrochemical Cells Utilizing Taylor Vortex Flows, application Ser. No. 12/800,658 of 20 May 2010, now U.S. Pat. No. 8,017,261 of 13 Sep. 2011;
Case A1: Electrochemical Cells Utilizing Taylor Vortex Flows, application Ser. No. 13/194,049 of 29 Jul. 2011, now U.S. Pat. No. 8,283,062 of 9 Oct. 2012, which is a division of application Ser. No. 12/800,658 (Case A);
Case A2: Galvanic Electrochemical Cells Utilizing Taylor Vortex Flows, application Ser. No. 13/235,480 of 18 Sep. 2011, now U.S. Pat. No. 8,187,737 of 29 May 2012, which is a continuation-in-part of application Ser. No. 13/194,049 (Case A1), which is a division of application Ser. No. 12/800,658 (Case A), now U.S. Pat. No. 8,017,261 of 13 Sep. 2011;
Case B: Fuel Reformers Utilizing Taylor Vortex Flows, application Ser. No. 12/800,710 of 20 May 2010, now U.S. Pat. No. 8,187,560 of 29 May 2012;
Case C: Chemical Process Accelerator Systems Comprising Taylor Vortex Flows, application Ser. No. 12/800,657 of 20 May 2010, now U.S. Pat. No. 8,147,767 of 3 APR 2012;
Case D: Direct Reaction Fuel Cells Utilizing Taylor Vortex Flows, application Ser. No. 12/800,672 of 20 May 2010, now U.S. Pat. No. 7,972,747 of 5 Jul. 2011;
Case E: Dynamic Accelerated Reaction Batteries, application Ser. No. 12/800,709 of 20 May 2010 with Philip Michael Lubin and Daniel Timothy Lubin, now U.S. Pat. No. 7,964,301 of 21 Jun. 2011.
Case F1: Cross-Flow Electrochemical Batteries, application Ser. No. 13/171,080 of 28 Jun. 2011, now U.S. Pat. No. 8,158,277 of 17 Apr. 2012, claiming benefit of U.S. Provisional Patent Application No. 61/388,359 filed 30 Sep. 2010, and of International Patent Application No. PCT/US10/39885 filed 25 Jun. 2010, which is a continuation-in-part of U.S. patent application Ser. No. 12/800,658 (Case A now U.S. Pat. No. 8,017,261 of 13 Sep. 2011); Ser. No. 12/800,710 (Case B now U.S. Pat. No. 8,187,737 of 29 May 2012); Ser. No. 12/800,657 (Case C now U.S. Pat. No. 8,147,767 of 3 Apr. 2012); Ser. No. 12/800,672 (Case D now U.S. Pat. No. 7,972,747 of 5 Jul. 2011); and Ser. No. 12/800,709 (Case E now U.S. Pat. No. 7,964,301 of 21 Jun. 2011)—all filed on 20 May 2010;
Case G: Thick Electrode Direct Reaction Fuel Cells Utilizing Cross Flows and Taylor Vortex Flows, application Ser. No. 13/174,686 of 30 Jun. 2011, now U.S. Pat. No. 8,124,296 of 28 Feb. 2012;
Case H: Galvanic Electrochemical Cells For Generating Alternating Current Electricity, application Ser. No. 13/437,771 of 2 Apr. 2012 with Sheldon L. Epstein, now U.S. Pat. No. 8,394,518 of 12 Mar. 2013; and
Case J: Taylor Vortex Flow Electrochemical Cells Utilizing Particulate Electrolyte Suspensions, application Ser. No. 13/789,844 of 8 Mar. 2013.

The enumerated applications are incorporated herein by reference in their entirety.

### COMMON OWNERSHIP OF RELATED APPLICATIONS

Halbert Fischel is an inventor of all of the applications and patents enumerated above. All rights to this application and all of the enumerated applications and patents, including all of the inventions described and claimed in them, have been assigned to the same assignee of this application so that there was common ownership of all of these applications and patents at the time the invention described and claimed below was made.

### FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF INVENTION

1. Field of the Invention

This invention is in the field of galvanic electrochemical fuel cells used to convert chemical energy of hydrogen-containing fuels (e.g., hydrogen, methane, methanol, borohydride) into electrical energy and having means to provide relative motion between an element and an electrolyte containing galvanic particles—including means for creating Taylor Vortex Flows (TVF) and Circular Couette Flows (CCF) in the electrolyte (U.S. Class 429/7, 50, 51, 67, 69, 72, 408; Int. Class H01M-14/00, 10/44, 2/38, 2/36 8/06) to promote generation of electricity.

2. Description of Related Art

As described in Case H, two methods of converting chemical energy into electrical energy are a) burning fuel (e.g., coal, natural gas, liquid hydrocarbons) with oxygen to create heat in an engine used to provide mechanical power to an electrical generator or alternator and b) promoting a reduction-oxidation (redox) reaction in a chemical cell that generates an electrical current in a circuit external to the cell. The former method can provide direct current (DC) or alternating current (AC); however, the process is Carnot ΔT temperature-limited by materials and therefore efficiency of burning fuel for electrical energy is low in accordance with the Second Law of Thermodynamics. While the galvanic cell method is also constrained by the Second Law of Thermodynamics (in that entropy change, TAS, at chemical and thermal equilibrium can approach the difference between H, enthalpy and G, Gibbs free energy) it can therefore be highly efficient. This Specification describes novel galvanic fuel cells for generating utilizing chemical energy to provide electricity.

Fuel cells are galvanic cells used to convert chemical energy into electrical energy—usually through use of catalysts that support reduction-oxidation (redox) chemical reactions. They are distinguished from batteries and flow cells that depend on faradaic reactions, can be electrically recharged and cannot react with hydrogen-based fuels. They are also distinguished from electrolytic electrochemical cells that require electrical energy to initiate and sustain electrochemical reactions (e.g., electrowinning), which are usually irreversible. Also, electrolytic cell electrodes do not contain catalytic or faradaic materials.

As used here, the term galvanic materials includes catalytic materials that support redox reactions but are not chemically altered as a result. Some examples include metals from Group 10 of the Periodic Table of the Elements, some alloys, such as Pt—Ru, and some molecules including a metal, such as MnO₂.

In general, fuel cells exploit three-phase (catalyst-fluid-electrolyte) electrochemical reactions where the fluid is selected from a set consisting of fuel and oxidizer. These reactions separate electrons from atoms or molecules, which then become energized ions (e.g., protons, hydroxides). The electrons travel from one electrode to the other electrode through an external electrical circuit where work is performed while the ions travel through a fluid electrolyte between the electrodes.

Patent applications, publications and patents of Halbert Fischel enumerated above—as well as prior art references cited in them—describe examples of galvanic cells that generate electricity. These cells include fuel cells that store chemical energy in their fuels

### General Description of the Invention

Cases A, A1, A2, D, E, G, H and J teach the use of TVF and CCF to improve the performance of fuel cells, batteries and flow cells incorporating a single electrolyte or two dissimilar electrolytes together with electrodes containing faradaic or catalyst particles and current collectors that do not contain any galvanic materials. Additionally, TVF (also known as Taylor-Couette Flows) enhance reaction rates in electrochemical cells by a) reducing mass-transport losses, b) preventing fuel and oxidizer crossover, c) capturing reaction products that can degrade catalysts and electrolytes and d) eliminating those degrading reaction products from the cells, e) increasing temperature to reduce electrode overpotentials and raise reaction rates and f) permitting higher pressures and concentrations to accelerate reactions at both electrodes.

TVF has a unique property of keeping fuel and oxygen gases separated so long as they are present only as gases. That is because each unreacted gas is trapped within bubbles at its respective vortex center. Thus, TVF eliminate any need for membranes used in conventional fuel cells. Case A provides a description of TVF.

This invention is a class of TVF galvanic electrochemical cells (e.g., Case A2 and Case H) with improved electrolytes containing suspensions of particles with galvanic materials for generating electricity. These are flowable electrolyte suspensions where particles are free to move with and within a carrier electrolyte fluid—as distinguished from particles that are fixed to an electrode or otherwise unable to move.

An important concept of this invention is the novel use of fluid dynamics in galvanic cells. Conventional battery cells and flow cells not utilizing TVF; but, comprising electrolytes containing a variety of suspended particles, are known in the art (e.g., Patent Publication No. US2011/0200848 of 18 Aug. 2011 for a High Energy Density Redox Flow Device to Chiang et al). One reason that TVF fuel cells of this invention can outperform conventional fuel cells is that it utilizes fluid dynamics to configure components that improve how particulate suspensions interact with current collectors in electrolyte chambers.

In prior art fuel cells, catalytic materials are affixed to electrically-conducting structures (e.g., electrodes, current collectors) of finite dimensions. In some fuel cells, the electrode structure is porous so that the amount of catalytic material per unit area of structure or electrolyte flow can be increased. Both the specific activity (SA) of the catalytic material in or on the electrically-conducting structure and ion diffusion path length through electrolyte to the complementary electrode limit current and power density. This is true even though all spatially distributed catalytic material can participate in simultaneous redox reactions.

In prior art fuel cells, catalyst SA depends upon catalyst surface access to dissolved gas (e.g., fuel or oxidizer and redox reaction products) mass transport through a thin electrolyte layer. Catalyst porous substrates (e.g., carbon) are deliberately made to be hydrophobic (e.g., coated with PTFE) in order to promote gas access to the catalyst. Hydrophobicity limits the ability of the carbon substrate to participate in ion exchange current or capacitive charge storage. Liquid electrolyte must penetrate the porous substrate to provide an electrolyte coating to the catalyst surface for a redox reaction. Hydrophobic catalyst porous substrates severely limit the amount of active catalyst surface that can participate in a redox reaction.

The embodiments to be described below are improvements over teachings in Case A2 and Case H. In this invention, the electrically-conducting component structure containing galvanic material is divided into small particles—each resembling a small element of the typical galvanic electrically-conducting structure. These particles are called charge transfer particles (CTP). The CTP are mixed with the electrolyte (e.g., KOH) to form a suspension, which may be a non-Newtonian (e.g., thixotropic) fluid.

Thixotropy is the property of certain non-Newtonian fluids that are thick or viscous under normal conditions; but, become less viscous over time when shaken, agitated, spun in TVF or otherwise stressed. They then take a fixed time to return to a more viscous state. Newtonian fluids (e.g., aqueous KOH as used in prior art fuel cells and batteries) exhibit linear relationships that converge at zero between shear stress and shear rate. By contrast, a thixotropic fluid (e.g., aqueous KOH containing suspended CTP) is a non-Newtonian fluid that requires a finite time to attain equilibrium viscosity or shear stress when introduced to a step change in shear rate.

Novel configurations of fuel cells of this invention generate dynamic forces in the fluid that accelerate CTP in the electrolyte suspension, where galvanic reactions take place, to make low-electrical-impedance, brief contact with the cell's current collectors. At any given instant, there are some CTP approaching the current collectors, some in contact with the current collectors and some departing from the current collectors. Not all CTP are simultaneously in contact with the current collectors to participate in the current-producing reaction at a given moment; but, those that have been charged and make momentary contact with the current collector surface contribute to the cell's electrical current. Novel structures are provided to assure that population and frequency of such contact is sufficient to support high current and power density.

Some prior art secondary storage cells (e.g., U.S. Pat. No. 7,252,898 to Markoski et al) and some fuel cells utilize laminar electrolyte flows to generate convection gradients in electrolytes that cause Newtonian fluid velocity vectors, both parallel and normal to current collector surfaces, electrodes and their adjacent Helmholtz layers, to approach zero. Prior art fuel cells do not use electrolyte particle suspensions. But for those battery cells that do use electrolyte particle suspensions, both a) the number of collisions between suspended particles and adjacent current collector plates and b) particle collision momenta are limited by a lack of fluid velocity vectors normal to the collector plates. This is one reason that current density in conventional cells is limited to low values (e.g., <0.5-Amperes per cm² of collector or electrode projected surface area at 1 volt). A number of techniques attempt to address this limitation.

Standard art battery architecture incorporates faradaic material into a thin paste wrapped under pressure or compressed into a porous cake or briquette where faradaic material is physically attached to metal current collectors or electrodes. A conducting additive (usually carbon) facilitates electrical conduction between finely divided faradaic particles. Another architecture physically attaches faradaic particles to porous electrode scaffolding. In all these prior art architectures, a good stable electrical conduction path from the faradaic particle to the metal current collector is sought. Faradaic particles in so-called semi-solid electrochemically active suspensions of prior art faradaic battery cells cannot, because of their very nature, provide that connection. Galvanic particle electrolyte suspensions containing catalyst have not been found in fuel cells.

For example, U.S. Pat. No. 4,126,733 of 21 NOV 1978 to Doniat teaches a faradaic battery cell incorporating an electrolyte containing low-density glass or plastic balls that are coated with zinc and have diameters in the range of 0.2 to 2.0-mm. While not expressly taught by Doniat, electrolyte suspension flow through the anode electrolyte chamber would have to be laminar (not turbulent) in order to limit pump power loss. Therefore, a particle velocity vector normal to the collector surface must approach zero for laminar flow, which means that current density must be low. Additionally, use of low-density balls that reduce particle collision momenta further reduces current density

Doniat's '733 battery patent seeks to overcome low current density limitations by teaching Advantageously, the transverse dimension of the compartment A (anode electrolyte particulate suspension chamber) is small in order to authorize (sic) as many impacts of the (low density) balls 18 on the (current) collector 14, for the sake of obtaining a yield of electrochemical oxidation as high as possible. However, reduction of the transverse dimension of the anode compartment reduces the number of balls available to complete a galvanic reaction and this also limits current density.

Further, narrowing a compartment while maintaining the pumping rate increases the shear rate in the compartment's electrolyte. This increases power requirements for pumping and therefore decreases net power available to a load.

A second example of a battery cell incorporating electrolyte with suspended particles is taught by Chiang et al in Patent Publication No. US2010/0047671 of 25 FEB 2010 for a High Energy Density Redox Flow Device. Chiang et al teach faradaic cells employing fine particles of 2.5-to-10-micron suspended in electrolytes—such as slurries, particle suspensions, colloidal suspensions (sols), emulsions, gels, or micelles where particles suspended in electrolyte act as electrodes that participate in faradaic redox reactions adjacent to non-reactive current collectors.

Chiang et al ('671 at Paragraph [0115]) also teach: In some embodiments, the rate of charge or discharge of the redox flow battery is increased by adjusting the interparticle interactions or colloid chemistry of the semisolid to increase particle contact and the formation of percolating networks of the ion-storage material particles. In some embodiments, the percolating networks are formed in the vicinity of the current collectors. In some embodiments, the semi-solid is shear-thinning so that it flows more easily where desired. In some embodiments, the semi-solid is shear thickening, for example so that it forms percolating networks at high shear rates such as those encountered in the vicinity of the current collector.

A liquid that is percolating is, by definition, moving slowly or gradually—especially as compared to a liquid in a TVF cell (e.g., Case A2, Case H) that is propelled by convective flow. When compared with TVF cells, entrained particles of Chiang et al in percolating liquids have much lower momenta and those momenta vectors are mainly parallel to the surfaces of the current collectors. Therefore, a particle in percolating flow has a velocity vector component orthogonal to the collector surface that must approach zero, which means that current density must be low—on the order of a few milliamperes per square centimeter of projected current collector area.

Chiang et al teach additional battery cells incorporating fine, micron-sized particles suspended electrolytes in Patent Publication No. US2012/0164499 of 28 JUN 2012 for a Stationary, Fluid Redox Electrode. These particles have sizes ranging from 10-microns to less than 1-micron. Other references to similar battery cells include Patent Publication No. US2011/0189520 of 4 Aug. 2011 to Carter et al for a High Energy Density Redox Flow Device (2.5-to-10-micron particles); Patent Publication No. US2011/0200848 of 18 Aug. 2011 to Chiang et al for a High Energy Density Redox Flow Device (2.5-to-10-micron particles); Patent Publication No. US2011/0274948 of 10 NOV 2011 to Duduta et al an Energy Transfer Using Electrochemically Isolated Fluids (2.5-to-10-micron particles) and Duduta et al, Semi-Solid Lithium Rechargeable Flow Battery, Advanced Energy Materials (20 May 2011), Vol. 1, pp. 511-516 (nanoparticles and micrometer-scale particles). Chiang et al is an inventor or author with others of each of these references. None of these references teach entrained particle momenta vectors that are orthogonal to current collector surfaces.

Percolating flows and other convection flows taught by Chiang et al create laminar boundary layers at current collector surfaces. The resulting shear forces are parallel to the current collector surfaces and these shear forces push the entrained particles away from the current collector faces. For that reason, finely divided particle collisions with the current collectors and consequent ion transfer across a cell do not occur in sufficient numbers to support high current density.

As will be described below, TVF cells of this invention do not use fine particles; but instead, contain bigger particles having greater densities than the particles taught by Chiang et al. Therefore, these particles can be launched with greater energy available to penetrate laminar flows created by CCF at the current collector surface. The larger CTP are integrated structures that comprise finely divided particulate matter for greater chemical reactivity.

When a charged particle suspended in electrolyte collides with the current collector and electrical contact is made, then the charge is transferred and the particle's attributes change from more-or-less dense to less-or-more dense as its composition changes (e.g., ZnCl² [symbol] Zn²⁺+2Cl). Size, shape and other attributes may also change.

For example, a Ni(OH)₂ particle (density of 4.10 g/cm³) colliding with a current collector (in a battery undergoing charging) will release protons (H⁺) and undergo crystalline realignment to become a NiO(OH) particle (density of 3.97 g/cm³), which differs not only in density but also the amount of intercalation of water and cations such as K⁺. Thus, the particle transforms into a different species. Fluid dynamics have little effect on these species transformations in conventional galvanic cells, such as the Chiang et al cells; however, consequences are different in TVF galvanic cells.

Once a particle in a TVF cell transforms into a different species after collision with a current collector, it will be drawn back into the TVF because of vortex fluid dynamics and because of its change of momentum upon collision with the current collector. Upon return to the TVF, the particle is available for repeated charge or discharge. This particle species feature discrimination cannot be exploited in the Chiang et al galvanic cells that rely on laminar flow because particles in a flow stream near the current collectors will remain near the current collector. Further, recently discharged particles impede approaching charged particles from contacting the current collector.

Chiang et al teach that this limitation at the surfaces of the current collectors can be overcome by vigorous mechanical stirring. However, mechanical stirring of a suspension contained within vessel walls creates a tangential shearing boundary layer of nearly pure electrolyte adjacent the current collector surfaces. This boundary layer will cause an anisotropic suspension of particles (especially very small particles surrounded by a film of attached electrolyte) to avoid the current collector.

Chiang et al also teach that heating and cooling will produce convective vortices rising normally from cell walls in accordance with the Rayleigh-Bénard theory of vortex flows; however, these flows will drive particles away from, not toward, the current collector surfaces because they also create current collector surface boundary layers. Percolation from a current collector will produce the same result.

Current density is related to the number of suspended particles (e.g., CTP) that are displaced from near the current collectors after collisions. However, there is less particle kinetic energy available in a Chiang et al cell from Rayleigh-Bénard vortex flows or percolation flows to move the transformed particles away from the current collector and expose its surface to approaching particles than is the case for stirring.

Stirring, which occurs in both Chiang et al cells and TVF cells, has different consequences in each type of cell. In Chiang et al cells, stirring of fine particle suspensions would provide a modest improvement; however, is does not solve the problem of particle depletion caused by laminar boundary flow in proximity to current collector surfaces. Roughening current collector surfaces would increase particle collisions; but, it would not supply sufficient energy that is needed to establish good electrical connections between the particles and the current collector surfaces. Thus, the current density will be lower in the Chiang et al cells than in TVF cells of this invention because there are fewer particle collisions having good electrical connections with current collectors per units of time and surface area in a Chiang et al cell than in a TVF cell.

Ten-micron and smaller particles in suspension as taught by Chiang et al offer no advantage to TVF cells because these particles would remain trapped within vortices and rarely collide with current collectors. Particles for use in TVF cells of this invention have different sizes, shapes and density ratios with respect to the suspending fluid and net mass so that they will not have any stable position within a TVF vortex. When these particles are at the periphery of a vortex, the particles will have gathered sufficient angular momentum to escape from the vortex and will be launched with considerable force for collision against a current collector surface (especially a roughened one). When such a particle makes strong electrical contact with the current collector, it becomes an electrode for an interval of time sufficient to transfer electrical charge. Upon collision, the particle, will change species and lose angular momentum (seen as a torque in the system) and quickly (within a millisecond or less) be drawn back into the vortex in a rapid, repetitive cycle.

Nano-size particles can be used in TVF providing they are accompanied by large metal conducting particles. These large metal hydrophilic particles, coated with galvanic suspension, act as sledgehammers that drive the faradaic or galvanic particles into a current collector. A better particle suspension alternative comprises finely divided nano-size faradaic or galvanic particles attached to the large micron-size metal particles.

After particles collide with the current collector surface and electrical charges are transferred, ions (e.g., H⁺, OH⁻) are released into the electrolyte solution. In the case of Chiang et al cells, protons move slowly along paths orthogonal to the current collector surfaces toward the opposite current collector. Only small diffusion, concentration and migration gradient forces slowly propel these ions through the electrolyte to complete the cell's internal chemical circuit. If electrolyte is pumped through the cell, then the ions must move across the cell along paths that are orthogonal to electrolyte convection flows, which do not provide any acceleration to the ions toward an opposing electrode. Further, the ions in Chiang et al cells must permeate an ion permeable separator, such as a NAFION™ membrane, that increases the cell's internal resistance.

By contrast, ion movement in TVF cells, such as those taught in Case A2, is very rapid because of convection currents. The ions are sequestered by high-shear-rate convection gradient forces generated by CCF that rapidly accelerate the ions from the current collector surfaces toward the rotating filter of Case A2 cells. Once at the filter, the ions can pass through the filter and enter the CCF on the opposite side for transport to the opposite current collector or they can combine with other ions near the filter to produce a reaction product (e.g., H₂O) in the electrolyte. Note that TVF cells do not require ion permeable separators such as NAFION™ proton exchange membranes.

TVF cells have unique flow properties that are exploited to increase mechanical forces that aid in charge transfer by particles not taught in the prior art for use in galvanic cells. As described above, the Chiang et al particles flow tangentially past the current collector as an isotropic suspension. This can also occur in a TVF vector field. However, if a particle has particular size, shape, mass and density ratio with respect to its suspending fluid, then it will not have a stable position within a TVF vortex and will be thrust radially (not axially as in a Chiang et al cell) toward a collision with a current collector.

When particles reach the periphery of a vortex, the particles have attained sufficient angular momentum to escape the vortex along a radial trajectory and be launched with considerable force against the current collector surface. If the particle is charged, then the collision of a particle with the current collector surface—especially a roughened surface—will cause the particle to transfer charge to the current collector, change species, instantly lose angular momentum and then be drawn back into the vortex. This sequence of events occurs in a rapid repetitive cycle.

If the Chiang et al suspensions of finely divided faradaic particles in liquid electrolyte are to be used in a TVF galvanic cell, then they require an addition of larger conducting particles acting as sledgehammers in order to effectively transfer charges to the TVF current collectors. These larger particles must be of a volume fraction that would not exceed the faradaic or galvanic material. Even higher current densities can be obtained by attaching the faradaic or galvanic materials directly to the large conducting particles.

For example, consider Ni or stainless steel particles having an enclosing sphere diameter in the range of 75 to 130-micron (75-130 μm) (4 to 13 times the diameter of the Chiang et al particles) for use in a TVF cell having a 1 to 2-mm gap and spinning at 3600-RPM. These particles will have a mass of ≈1 to 20×10⁻⁶-grams depending upon shape selected from a range extending from spherical to flake. Their forces at impact can be estimated. For smaller diameter filters, narrower gaps and higher rotational speeds; particle sizes in the range 30-75 microns and masses in the range or 0.5−1.0×10⁻⁶ grams are useful.

The impulse, J=∫ₜ_{₁}^{t}^{₂}mdv=∫ₜ_{₁}^{t}^{₂}Fdt,=F_{avg} (t₂−t₁) of a particle upon striking a current collector is due to a loss of virtually all of its angular momentum in the range of J=(mΔv−0) where Δv is approximately 600 cm/sec. Peripheral TVF vortex speed closely approximates the filter surface speed. For any gap width in the range of 1 to 2-mm, Δ(mv) will be in the range of 3.2 to 16×10⁻³-gm-cm/sec.

An important parameter is the interval of action, Δt=t₂−t₁. A particle moving at 600-cm/sec. at the periphery of the vortex can travel about 0.005 to 0.01-mm (the thickness of the CCF boundary layer) before surrendering its momentum to the current collector. The impulse interval is thus about 1.25 to 6.25-pec for 1 to 2-mm gaps, respectively. The actual interval, based upon torque calculations, which are more accurate, is shorter. Consequently, a conservative estimate of the impulse (taken over a 1×10⁻⁵ second interval) in terms of force transfer is F_{avg}=240 to 1,200-gm-cm/sec² (dynes)=5.4×10⁻⁴ to 2.7×10⁻³-lbs. of force.

The size and shape of the particle limits the contact area to about a 25-micron radius circle for a contact area of 76×10⁻⁸ square inches, assuming some particle deformation at contact with a suitably roughened surface. Therefore, the contact pressure is greater than 690-psi (47-atm) and less than 3,450-psi (235-atm) for TVF gaps in the range of 1 to 2-mm and 3600-RPM. That pressure is both far greater than the contact pressure attainable with the Chiang et al 10-micron or smaller, fine particles and more than adequate to secure complete charge transfer. It is also sufficient pressure to cause particle deformation, which will lower the contact pressure while increasing the contact area between the particle and the current collector surface. Increasing the contact area will lower the current density in the point of contact and thereby reduce I²R heating losses where the current collector has contact with the particle.

By contrast, prior art 1 to 10-micron or smaller galvanic particles have a mass of ≈4 to 200×10⁻⁸-grams, depending upon material and shape selected. Because of their small sizes, these particles are enclosed by surface layers of electrolyte that have relatively high surface tensions, so the particles remain in isotropic suspension or settle out very slowly.

Thorough stirring of these Chiang et al fine particle suspensions tends to sustain isotropic distributions of particles—except adjacent to electrode or current collector surfaces. For this reason, the particles will remain in laminar flows of conventional cells and rarely touch current collector surfaces to convert to other species. U.S. Pat. No. 7,252,898 of 7 Aug. 2007 to Markoski et al teaches that multi-stream laminar flow of two electrolytes over electrodes to form stratified layers that do not mix—even in the absence of a physical barrier. This inability to mix retards transverse particle movement needed for electric current generation in conventional cells.

In TVF cells, 10-micron and smaller fine particles would remain within the vortex in stable concentrations. The particles would rarely acquire sufficient angular momenta to escape the vortex, contact the current collector and contribute to the cell's electrical current. This is why 35 to 100-micron-size particles, depending upon core metal density, are needed to carry fine galvanic particles toward collisions with current collectors. This is stark contrast to the Chiang et al teaching at Paragraph of their '499 publication where they state: Furthermore, the electrode active materials do not include materials that are added to facilitate the transport of electrons from an electrode current collector to the electrode active material (i.e., additional materials that increase the electronic conductivity).

The prior art does not teach the importance of assuring low impedance charge transfer from galvanic particles or materials in suspension (often referred to as electrodes to be distinguished from suspending electrolyte) to current collectors. Perhaps, it is assumed that the contact of active material with current collector surfaces is sufficient to cause charge transfer when, in fact, such contact infrequently occurs. Chiang et al describe viscosity in relation to shear rate; but fail to state that the highest shear rate and lowest viscosity occurs at current collector boundary surfaces where the galvanic particle population is largely depleted. The low numbers of particles near the current collectors together with their parallel flow path vectors contribute to low numbers of particle contact with the current collector and limit current density. This is not what occurs in TVF cells of this invention.

It is therefore a first advantage of the present invention provides an improvement over earlier galvanic cells by providing galvanic TVF cells comprising catalytic CTP in electrolyte suspensions that are especially configured for use with TVF.

A second advantage of the present invention provides an improvement over earlier galvanic cells through use of particles in electrolyte suspensions that have 35 to 100-micron diameter (enclosing sphere) particles.

A third advantage of the present invention provides an improvement over earlier galvanic cells through use of particles in electrolyte suspensions that have mass of at least 1×10⁻⁶-grams per particle.

These advantages are more fully set forth in the following descriptions of preferred embodiments of this invention.

### BRIEF DESCRIPTIONS OF THE SEVERAL VIEWS OF THE DRAWINGS

FIG. 1 is a cross section drawing of a TVF fuel cell of this invention.

FIG. 2A is a conceptual cross-section view of a fuel cell pore taken from the prior art.

FIG. 2B is a conceptual cross-section view of a fuel cell pore of this invention.

FIG. 3A is a conceptual cross-sectional illustration of a charge transfer particle decorated with catalyst particles.

FIG. 3B is a conceptual cross-section drawing of a catalyst particle for attachment to a charge transfer particle of FIG. 3A.

FIG. 4 is a conceptual illustration of how an electron is transferred from a charge transfer particle in TVF to a current collector and how a proton cation is propelled by CCF toward a hydroxide anion at a rotating filter.

FIG. 5 is a conceptual illustration of an alternative current collector incorporating a surface of galvanic material.

### DETAILED DESCRIPTION OF THE INVENTION

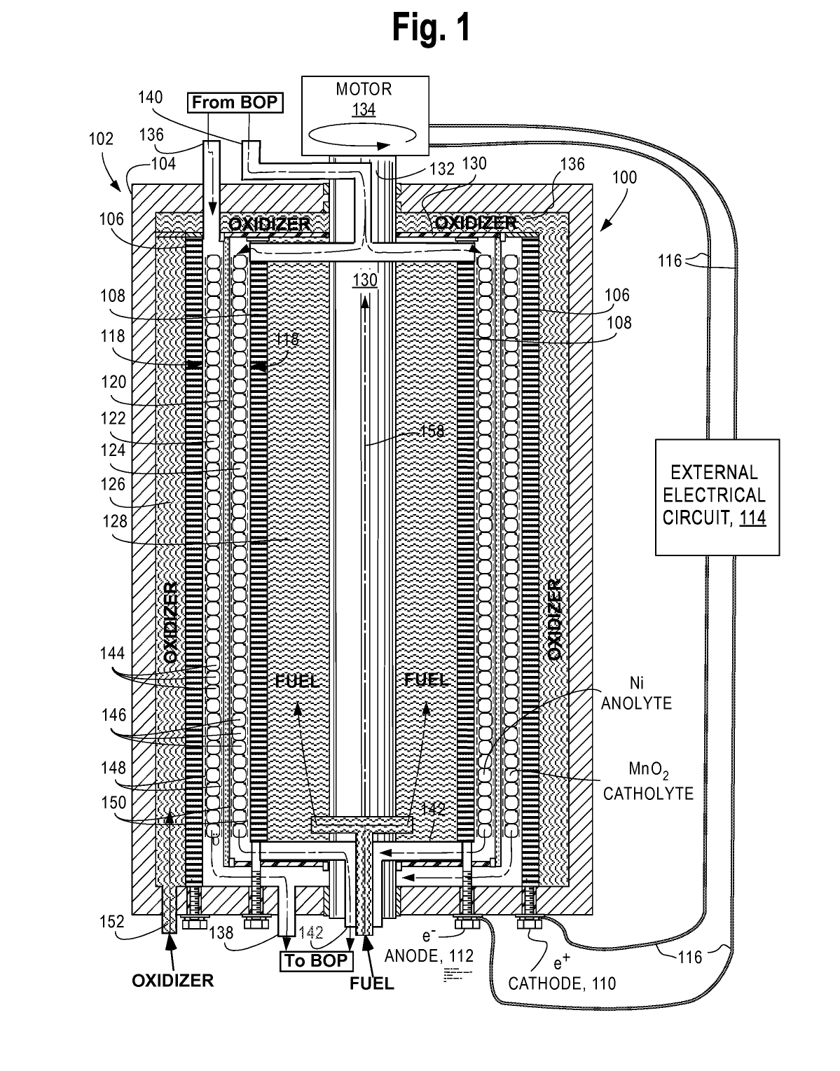

FIG. 1 is a cross-sectional view of essential features of a preferred embodiment of an electrochemical cell 100 comprising a fuel cell 102. The fuel cell 102 is similar to the fuel cell 602 of Case A2, with some important improvements that are to be described.

The fuel cell 102 is contained within a case 104 and comprises a cylinder-like outer current collector 106 that is secured to the case 104 and a cylinder-like inner current collector 108 that is also fixed to the case 104. The outer current collector 106 is connected by positive terminal 110 (CATHODE) and the inner current collector 108 is connected to the negative terminal 112 (ANODE), respectively, to external electrical circuit 114 by conductors 116. Both of the current collectors 106, 108 have a very large number of very fine pores extending radially from their outer to their inner surfaces; however, open-cell metal foams and other electrically-conducting porous materials also can be used.

In this embodiment, the outer current collector 106 forms a coaxial right-circular cylinder as shown in FIG. 1; however, this attribute is not a requirement and other cylinder-like geometries (e.g. elliptical, conical, hyperbolic, irregular, different axes) may be employed. The same is true for inner current collector 108. A prerequisite is that there are two electrolyte chambers separated by a filter that is permeable to flow of electrolyte; but, not particles entrained in the electrolyte. Additionally, there must be means for rotating the filter to create a vortex in the electrolyte in one of the electrolyte chambers.

A gap 118 between the outer current collector 106 and the inner current collector 108 is divided by a filter 120 into an outer electrolyte chamber 122 and an inner electrolyte chamber 124. The filter 120 in this embodiment is also a right-circular cylinder that is coaxial with the current collectors 106, 108; however, the filter 120 may be cylinder-like and it need only be approximately coaxial with the outer current collector 106 and the inner current collector 108. In the embodiment of FIG. 1, the inner surface of the current collector 106 and the outer surface of the current collector 108 are electrolyte-facing surfaces of these porous current collectors (106, 108).

The filter 120 is permeable to the flow of electrolyte, water and ions; but not to particles. This feature distinguishes the filter 120 from ion-permeable membrane 208 (e.g. NAFION® and LISICON™ ion-exchange or ion-conducting membranes) that is shown in FIG. 5 of Case E. and that is impermeable to electrolyte, water and particles. Those membranes are popular choices for use in prior art aqueous fuel cells. NAFION® membranes only transport cations (e.g., protons) and limit the chemistries that can be employed to only those using acidic electrolytes. By contrast the filter 120 in the TVF fuel cell 102 is compatible with both acid and alkaline chemistries, tolerates higher operating temperatures and facilitates water balance between the cathode and anode sections of the fuel cell 102

In this embodiment, a catholyte flows in the outer electrolyte chamber 122, which is in the gap 118 between the filter 120 and the outer current collector 106. An anolyte flows in the inner electrolyte chamber 124, which is in the gap 118 between the filter 120 and the inner current collectors 108. If another chemistry is selected, then the electrolyte chambers 122, 124 can be exchanged for anolyte and catholyte, respectively.

Also in this embodiment, an oxidizer chamber 126 is formed between the case 104 and the outer current collector 106. A fuel chamber 128 fills the interior of the inner current collector 108. If another chemistry is selected, then the oxidizer chamber 126 and the fuel chamber 128 can be exchanged for fuel and oxidizer, respectively.

Catholyte flowing in the outer electrolyte chamber 122 comprises a non-Newtonian or thixotropic fluid mixture of an electrolyte such as KOH (an alkaline electrolyte) and catholyte catalyst particles (e.g., containing MnO₂). Similarly, an anolyte flowing in the inner electrolyte chamber 124 comprises a thixotropic mixture of the same electrolyte and anolyte catalyst particles (e.g., containing Ni, NiO or noble metal catalysts). The filter 120 is porous to the electrolyte; but, impermeable to both types of particles.

The catholyte and the anolyte particles, also called charge transfer particles (CTP), each serve as electrodes because the catholyte and the anolyte particles comprise galvanic (catalyst) materials that are sites where three-phase galvanic reactions occur between the particle surfaces and the electrolyte as the CTP travel through the electrolyte. The CTP also transfer charges when CTP make momentary electrical contact with metal current collectors 106 and 108. By separating the redox reactions of the CTP electrodes from current collection, the redox reaction process and current collection functions, together with their supporting structures, can be optimized. Both anolyte and catholyte suspensions may include dispersion or wetting agents (e.g., etidronic acid, also known as HEDP, lignin sulfonic acid, etc.) and particles that facilitate electron charge transfer at metal electrode surfaces (e.g., cobalt, Co(OH)₂, BaSO₄ etc.).

As used here, the term galvanic materials include catalytic materials. In general, the galvanic fuel cell 102 comprises, in one case, three-phase (catalyst—fuel or oxidizer—electrolyte) electrochemical reactions that separate electrons or ions (e.g., protons) from atoms or molecules. The electrons travel from one electrode 108 to the other electrode 106 through the external electrical circuit 114 where work is performed while the ions travel through a fluid electrolyte between the electrodes 106, 108.

Unlike the outer current collector 106 and inner current collector 108 that are fixed to the case 104, the filter 120 is journaled for rotational movement within the gap 118 between the current collectors 106 and 108 to generate Taylor Vortex Flows and Circular Couette Flows in at least one of the electrolyte chambers 122, 124. The top of the filter 120 is secured to hub 130 that is fixed to the axle 132 of motor 134. The motor may be connected in parallel to the external electrical circuit 114 by conductors 116.

The catholyte from a balance of plant, BOP, enters the outer electrolyte chamber 122 through input orifice 136 and returns to the BOP after exiting through catholyte output orifice 138. Similarly, the anolyte from BOP enters the inner electrolyte chamber 124 through anolyte input orifice 140 and returns to the BOP after exiting through anolyte output orifice 142. The BOP may contain pumps (not shown) to accelerate electrolyte flows and may provide reservoirs of large volumes of catholyte and anolyte.

The filter 120 serves two principal functions. First, it prevents catholyte and anolyte particles from intermingling and neutralizing their charges by preventing crossover through the filter. Second, the filter 120 rotates between the outer electrolyte chamber 122 and the inner electrolyte chamber 124 to generate outer electrolyte chamber 122 flows, such as TVF 144, and inner electrolyte chamber 124 flows, such as TVF 146. Where TVF 144, 146 are generated, outer electrolyte chamber CCF 148 and inner electrolyte chamber CCF 150 can be generated, as described in Case A and Case A2. Third, the filter 120 facilitates water balance and accelerates inter-electrode ion exchange by permitting cross filter flows.

The filter 120 should have particular, if not especially unique, properties.

It should contain a dielectric material (e.g., PTFE) that prevents electrical shorting of the outer and the inner electrolyte chambers 122, 124 to each other. The filter 120 should be porous to the fluid component of the electrolyte suspension and it should be wettable (hydrophilic) in that fluid. The filter 120 should be smooth on both its faces. This means that surface pits and protuberances should be substantially smaller than the smallest particles 300, 402 in suspension. The filter 120 is provides dynamic surface rejection to prevent suspended particles 300, 402 from attaching to its surface or penetrating its pores.

Dynamic surface rejection requires a moving filter 120 surface as in TVF 144, 146, 404. The filter 120 surfaces are intended to wet and drag the fluid phase—not suspended particles 300, 402 that are carried in the fluid phase flow. For this reason, the current collector 106, 108, 406 surfaces are deliberately roughened to catch particles and transfer charge, even if only momentarily.

The fuel cell 102 is operated to produce electricity for transmission to the external electrical circuit 114 by a process comprising:
1. Filling the outer electrolyte chamber 122 with catholyte;
2. Filling the inner electrolyte chamber 124 with anolyte;
3. Pumping oxidizer through oxidizer port 152 into the oxidizer chamber 126 so that it penetrates the pores of the outer current collector 106;
4. Pumping fuel through fuel port 154 into the fuel chamber 128 so that it penetrates the pores of the inner current collector 108; and
5. Rotating the filter 120 at a rate of rotation adequate to cause—
   a. catholyte flows, such as TVF 144 and CCF 148, to form in the outer electrolyte chamber 122 catholyte, and
   b. anolyte flows, such as TVF 146 and CCF 150, to form in the inner electrolyte chamber 124 anolyte.
      Alternatively, the filter 120 can be rotated at a speed that will not produce TVF 146 or CCF 150; however, the fuel cell 102 will generate less electrical current.

Conventional fuel cells comprising porous electrodes, such as taught by Bockris et al, Modern Electrochemistry 2B, 2^{nd} ed., ©1998, Klewer Academic/Plenum Publishers, New York, §13.5.1—Special Configurations of Electrodes in Electrochemical Energy Converters”, pp. 1811-14 as well as typical proton exchange membrane (PEM) membrane electrode assemblies (MEA) containing stationary or static catalyst structures, are fundamentally different structures from TVF fuel cells incorporating catalyst structures taught here. In conventional fuel cells, charge transfer (current density) occurs within electrode pores and is primarily restricted to a narrow band of electrolyte within a meniscus where the meniscus is approximately 10-nanometers thick and in contact with catalyst on interior walls of the pores—as shown in Bockris et al FIGS. 13.12 & 13.13.

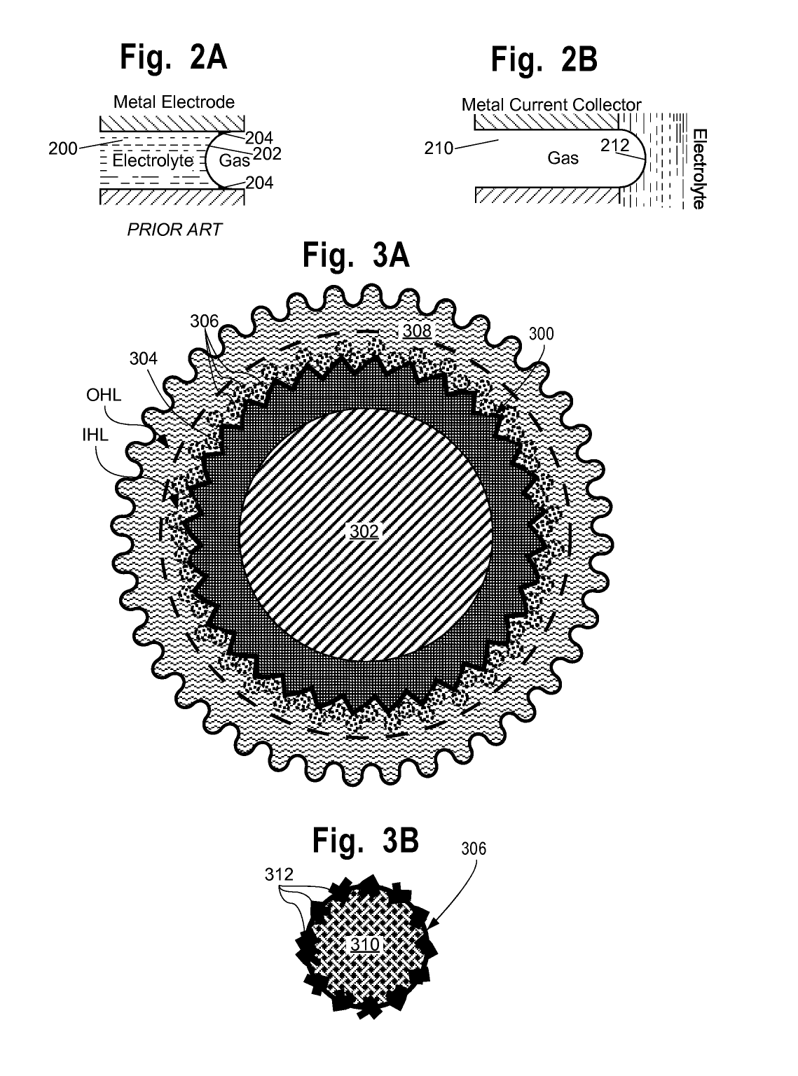

FIG. 2A, taken from Bockris et at FIG. 13.12, is a schematic representation of a three-phase interface in a single pore when the meniscus contact angle is a few degrees. Pore 200 in a fuel cell Metal Electrode contains both electrolyte and a fluid selected from a set consisting of fuel and oxidizer. A portion of the pore 200 wall is coated with or holds a catalyst.

A meniscus 202 separates the electrolyte from the fuel or oxidizer gas. The meniscus' surface tension regulates the amount of gas penetrating into the electrolyte. As the diameter of the pore decreases, the total catalyst surface area for a cell's electrode can increase; however, the surface tension of the meniscus also increases and less gas is able to penetrate the meniscus 202 and dissolve into the electrolyte. Therefore, a tradeoff between total catalyst surface area and the amount of gas penetration to the catalyst surface can exist.

The distance from the meniscus 202 to the wall of the pore 200 where the catalyst is located is critical to performance of the cell. Zone 204 illustrates where optimum results (e.g., highest current) can be obtained for a three-phase redox reaction of gas dissolved in electrolyte adjacent to catalyst. As explained in more detail by Bockris et al, if the distance is too high, then there is a large increase in limiting diffusion current. If the distance is too low, then there will be too much resistance to the flow of reaction products (e.g., H³O⁺ ions) back to bulk electrolyte. Thus, electrolyte and gas pressures in PEM fuel cells have to be stringently regulated to assure that optimum distances occur where the catalyst resides.

The volume of gas solvated in electrolyte of a PEM fuel cell can be increased by raising gas pressure; however, raising the pressure will require more accurate regulation to prevent an escalation in both the amounts of wasted fuel and mechanical stress on the PEM. The process of solvating gas in the electrolyte also can be accelerated by increasing temperature both to increase solubility and to lower meniscus surface tension; however, temperature is limited by a need to preserve structural integrity of the PEM. Alternatively, surface tension of the meniscus can be reduced by raising humidity of the gas (e.g., 80%); however, adding water will reduce the electrolyte's ability to transport of ions. These limitations on pore size, gas pressure, temperature and humidity combine to set low limits (e.g., <1000 ma/cm²) on conventional fuel cell current density.

Once there is a redox reaction, reaction products must diffuse to accommodate fresh fuel or oxygen. The requirement is difficult to satisfy for conventional cells containing PEM where only the margins of polymer electrolyte on catalyst bring the three phases together across a short diffusion path because only diffusion, concentration and migration gradient forces are available to remove the reaction products.

As can be seen from FIG. 2A, only a small fraction of static catalyst surface of the electrode in conventional cells participates in a redox reaction. The reaction is also restricted by mass transport rates. These two effects have not been separated in most experiments characterizing SA of various catalysts.

A theoretical calculation of the oxygen reduction reaction (ORR) on platinum (Pt) was made in Koper, Ed., Fuel Cell Catalysis—A Surface Science Approach, ©2009, John Wiley, NJ, §3—Electrocatalysis and Catalyst Screening from Density Functional Theory Calculations’ pp. 70. No mass transport limitations were taken into account because a vanishingly thin layer of electrolyte covering the entire catalyst area was assumed. Under such idealized conditions, sites are able to cycle the reaction at 200 times per second and produce a current density of 96 mA/cm² of catalyst surface. When measured experimentally using RDE (Rotating Disc Electrode) Koper, §15—Size Effects in Electrocatalysis of Fuel Cell Reactions on Supported Metal Nanoparticles’ pp. 533-536, the current density is 0.2 to 0.3 mA/cm² (FIG. 15.7 at p. 536). These are 0.2 to 0.3% of the theoretical value. Even highly active hydrogen produced, at most, 27 mA/cm² (page 532) and it was reported that the RDE would have to spin at 4.6×10⁸-RPM to eliminate the mass transport diffusion decrement through electrolyte; which obviously is not feasible.

While it is not possible to separate mass transport effects from 3-phase pore morphology effects vis-à-vis catalyst SA, a useful estimate of static catalyst effectiveness can be estimated. The surface area of highly-dispersed 3-nm platinum particles is 100 m²/gm. Typical hydrogen fuel cells incorporate about 0.2 mgm of platinum catalyst per cm² of projected electrode area, which yields about 200 cm² of platinum catalyst surface area per cm² of projected electrode area. For a hydrogen oxidation reaction (HOR), this amount of platinum catalyst produces a current density of about 0.5 A/cm² of projected electrode area. That estimate of current density is equivalent to 2.5 mA/cm² of platinum catalyst surface area or about 10% of the best experimental result for platinum catalyst using a rotating disk electrode (RDE) test to characterize platinum. The complementary oxygen reduction reaction catalyst (ORR) density is usually higher, at 0.5 mgm of platinum catalyst per cm² of projected electrode area or 500 cm² of platinum catalyst surface area platinum per cm² of projected electrode area. At 1 mA/cm² of platinum catalyst surface area, the oxygen cathode operates at about 1% of theoretical catalyst efficiency.

The total volume of platinum catalyst particles in the static catalyst structure examples is only 0.3% of the volume of a typically 30 μm thick active porous electrode layer adjacent the electrolyte or PEM. This means that the Pt particles only sparsely cover the electrode and the distance between particles is greater than the diameter of a virtual sphere enclosing a particle. Gas molecules diffusing through such a sparsely-seeded structure must waste a substantial portion of residence time while migrating to and react with catalyst particles.

The porous electrodes of the conventional fuel cells contribute to the internal impedance of the cells and limit electric current density for the following reasons:
Static catalyst structures are inherently limited to low current densities (e.g., decreasing pore sizes increases electrolyte meniscus surface tension—thereby decreasing gas solubility).
Narrow diameters of the pores impede the purging of reaction products moving outward from the pores and retard movement of electrolyte with dissolved gas inward to redox sites.
Ions (e.g., protons, hydroxides) are only propelled by diffusion, concentration and migration gradient forces that only move the ions at relatively slow velocities across the cell's internal chemical circuit.
PEM (e.g., NAFION® membranes) limit reaction temperatures.
PEM retard ion propagation across cells.
If CO or other harmful reaction products are produced, then an inability to promptly remove them may cause poisoning of the catalysts.
Electrolyte pressures and levels must be precisely monitored to prevent flooding of electrode pores, which would block gas access to the catalyst.
Where the electrode comprises catalyst supported on porous carbon and the porous carbon serves both as a diffuser of gas reaching the catalyst and an electrical double layer (EDL), then electrolyte necessary for charging the EDL restricts the flow of gas necessary for the redox reaction at the catalyst.

None of these limitations exist in TVF fuel cells.

FIG. 2B is cross-sectional view of a fuel cell pore 210 in a Metal Current Collector (e.g., 106, 108) of this invention. In contrast to the pore 200 of FIG. 2A the pore 210 of FIG. 2B contains only fuel or oxidizer gas. While electrolyte may be hydrophilic with respect to the pore 210 walls, it does not form an internal meniscus similar to the meniscus 202 of FIG. 2A because gas pressure creates an external electrolyte meniscus dome 212 outside of the pore. Since the pore 210 walls do not contain catalyst, the gas and electrolyte pressures need only be regulated to assure that electrolyte does not flood the pores and that the meniscus dome 212 does not become an ejected bubble that allows gas to escape into the electrolyte.

The gases penetrating the current collector pores reach current collector 106, 108 surfaces that are covered by electrolyte. The gases are restrained by electrolyte surface tension and form nano-size to micron-size convex domes 212 that protrude from the current collector 106, 108 surface pores. As will be described, these domes 212 are broken by particles in the electrolyte that collide with the current collector 106, 108 surfaces. Liberated gas, momentarily trapped and compressed between the current collector 106, 108 and the CTP 300 surfaces, is then forced into solution with the electrolyte attached to the catalyst on the CTP surfaces. In contrast to conventional fuel cells where the gases and electrolyte must penetrate the electrode pores, no electrolyte enters the TVF current collector pores.

The pores 200 occupy only 15-25% of the current collector 106, 108, 406 volumes, which can be very strong mechanical structures and only 10-15% open area on the current collector surface. The gas meniscus domes 212 cover much of the current collector 106, 108, 406 surfaces. Because the CCF 148, 150, 410 boundary layers cover static current collector surfaces, the gas does not leave the current collector 106, 108, 406 surfaces unless forced by excessive gas pressure.

In this first embodiment, the catalyst necessary to promote the three-phase reactions does not reside in the pore 210 walls; but on CTPs as shown in FIG. 3A. A typical CTP 300 comprises a metal core 302 surrounded by a rough-surfaced skin 304 of electrically-conducting material, such as carbon (e.g., particles, graphene, graphite, nano-tubes), to which catalyst particles 306 are attached. Each of the CTP 300 should have a mass of at least 1×10⁻⁶ grams and a density of at least 4 grams/cm⁻³ in order to escape the TVF 144, 146, 404. Therefore, each of the cores 302 should be a metal having a density of at least 8 grams per cm³ so that the CTP have densities of at least 4 grams/cm³. The cores 302 may contain tungsten, nickel, nickel alloys (e.g., INCONEL® alloy), stainless steels or similar metals.

The CTP 300 is entrained in electrolyte 308 that contains an Inner Helmholtz Layer (IHL) and an Outer Helmholtz Layer (OHL). The IHL and the OHL form the EDL on supported catalyst surfaces in the electrolyte that encapsulates the CTP 300. The EDL refers to two parallel layers of charge surrounding the CTP 300 that form a capacitive electrical energy store. The IHL is an electrical surface charge (either positive or negative) comprising ions adsorbed directly onto or into catalyst surfaces fully or partly covering the CTP 300 due to chemical interactions. The OHL is composed of ions attracted to the surface charge because of the coulomb force electrically screening the IHL. The OHL is loosely associated with the CTP 300, because the OHL is made of free ions that move in the electrolyte 308 under the influence of electric attraction and thermal motion rather than being firmly anchored. The EDLs are the sites of electrical charge that are subsequently transferred to the current collectors 106, 108.

A cross-sectional view of one embodiment of the catalyst particle 306 is shown in FIG. 3B. The catalyst particle 306 contains a catalytic metal core 310 of a first metal (e.g., platinum) that supports admetal islands 312 created by depositing a second metal (e.g., ruthenium) on the core 306 with a process that displaces surface atoms of the core 306 with atoms of the deposition metal to create the islands 312. One of the metals can contain an element selected from Group 10 of the Periodic Table of the Elements.

The admetal islands 312 have a bimetallic structure that is distinct from that of their component metals and can preferentially absorb OH⁻ ions. When hydrocarbon fuels (e.g., methanol) are reacted to create H₂, then CO is also produced. The CO would poison the surface of the catalytic core 310; however, the OH⁻ ions can oxidize CO to CO₂ and resist CO poisoning. In addition to protecting the surface of the core 310, the oxidation of CO to CO₂ provides an additional benefit of widening the choice of electrolytes to include both acid and alkaline solutions because CO poisoning is no longer a primary concern.

The catalyst particle may also comprise an inert heavy metal core metal selected from a set containing densities of at least 8 grams per milliliter (e.g., tungsten) covered by carbon (e.g., CNT). The carbon can support catalyst (e.g. NiOOH, Ni, MnO₂, one of the metals can contain an element selected from Group 10 of the Periodic Table of the Elements etc.).

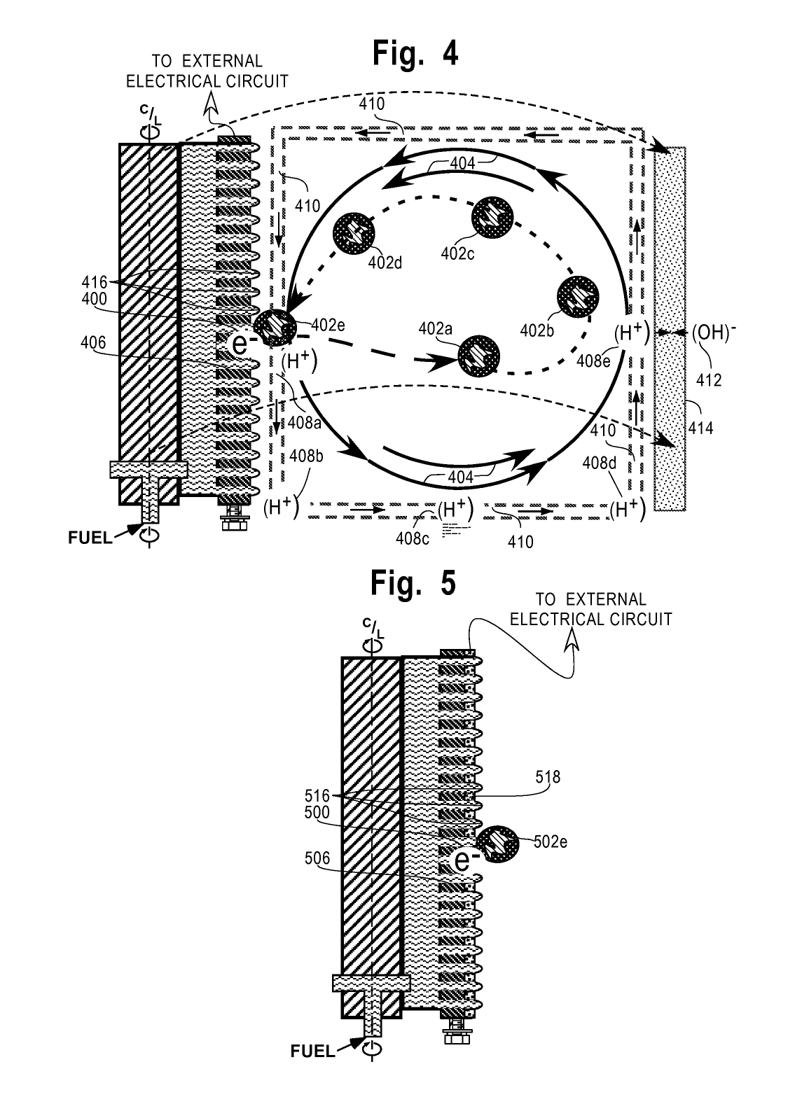

FIG. 4 illustrates how an electron (e) 400 is created on a CTP 402 in TVF 404 and then delivered to current collector 406 and how a cation (H⁺) 408 is released and propelled by high-shear-rate CCF 410 toward an anion (e.g., OH⁻) 412 at rotating filter 414.

The CTP 402 initially is trapped near the swirling center of TVF 404 at position 402a because its hydrodynamics are different from those of the electrolyte. After the CTP 402 collides with another similar particle (not shown) and acquires some of the other particle's kinetic energy, CTP 402 is accelerated to position 402b where centrifugal force and the velocity of the TVF 404 accelerate it to positions 402c and 402d before it enters high shear rate CCF 410 and collides with the current collector 406 at position 402e.

The first time that the CTP 402 collides with the current collector 406, the CTP 402 has little or no charge to transfer to the current collector 406. Nevertheless, the CTP 402 initiates a redox reaction by compressing meniscus domes 416, which cause release of fuel (e.g., H₂) into the CCF 410 where the fuel goes into solution with the electrolyte covering CTP 402.

The collision with the current collector 406 causes the CTP 402 to lose momentum and get drawn back into the TVF 404 to the position 402a. The collision with the current collector 406 also causes the CTP 402 to become coated with the electrolyte-fuel solution and the presence of fuel, electrolyte and catalyst initiates a three-phase redox reaction that charges the CTP 402. The CTP 402 has the benefit of a long interval as it returns to the center of the TVF 404 many times where it regains sufficient momentum to escape. This interval is sufficient for the redox reaction to convert almost all of the fuel chemical energy to electrical charge energy. Then, the next time that the CTP 402 collides with the current collector 406, the electron (e) 400 is transferred to the current collector 406 for passage to the External Electrical Circuit. A complementary scenario occurs for the oxidizer reduction reaction (ORR).

The fuel cell CTP 300, 402 continuously move from the TVF 404 to the current collector 106, 108, 406 surfaces and back again. When the CTP 300, 402 contact the current collector 106, 108, 406 surfaces, the CTP 300, 402 are replenished with gas liberated from the meniscus dome 416 that dissolves within the electrolyte 308 covering and attached to the CTP and enters the redox reaction. As the solute gas at the CTP 300, 402 catalyst surfaces is reacted, it is replenished by solute gas previously stored in the EDL. This reaction is a continuous process during the transit time between CTP 300, 402 collisions with the current collector 106, 108, 406 surfaces.

An alternative to the current collector 406 of FIG. 4 is shown in FIG. 5. Electron (e) 500 has been created on a CTP 502e that has collided with current collector 506 and meniscus domes 516. Whereas the current collector 406 of FIG. 4 has no galvanic properties and cannot participate in a redox reaction, the current collector 506 of FIG. 4 is a composite that contains a galvanic material coating 518 that is decorated with galvanic flakes.

The galvanic material cover 518 may comprise several layers of graphene or another active carbon, such as carbon nanotubes (CNT) or those used to construct supercapacitors. The coating 518 covers the metal current collector 506; but, not its microscopic pores. The layers serve as a substrate for catalyst (e.g., anode—Ni, NiO, etc.; cathode—MnO₂, etc.). The CTP 502 may have the galvanic properties of the CTP 402.

Alternatively the CTP 502 may be replaced by a metal particle (not shown) with similar mass and size; but, without galvanic properties. Gas will form meniscus domes 516 at the surface of the galvanic material cover 518 and the redox reaction will proceed as described for FIGS. 1-4.

The alternative structure of FIG. 5 may be preferred in some applications because processing of the anolyte and catholyte in the BOP may be simpler—especially if simple metal particles are substituted for the CTP 502. In other installations, the structure of FIG. 4 may be chosen because it is easier to replace CTP 402 than it is to exchange the current collector 506 with its galvanic material cover 518.

In TVF galvanic cells, high volumetric particle suspension concentrations in a range of 50% to 75% are most useful for storing energy. Particle-to-particle interactions and collisions are responsible for the distribution of particles within the vortex. Particles of sufficient size and mass or mass density that are located at the periphery of the vortex will momentarily escape the vortex—as will now be described.

Time or spatial variation of electrolyte suspension viscosity as a function of local shear rate is an important factor for TVF galvanic cells. The local shear rate can be estimated as S≈−∂L/∂mωr², where,
∂L is local angular momentum of a fluid mass element, ∂m,
r is the radial position of the fluid element, ∂m, with respect to the vortex spin axis, and
ω is the angular velocity of the fluid element, ∂m.
   ω is maximum at the center of the vortex where viscosity is at a minimum with respect to the value in the boundary layer adjacent the current collector metal surface.

The change in electrolyte suspension viscosity as a function of radial distance from the center of a vortex will cause time-dependent instabilities in the TVF laminar flow profile. These instabilities create local transient mixing vortices at the periphery of the TVF that originate at and depart from the facing surfaces (e.g., current collector, filter) and dissipate within the larger body of the main vortex. This occurs in a thixotropic non-Newtonian suspension; however, transient vortices cannot persist unless the transition to actual general turbulence is reached. There is no known analytical solution to distinct particle motion in TVF nor any known published work on the subject—except for filtration applications that focus on polarization layers of filter media.

Any two adjacent vortices 404 in a galvanic TVF cell share a peripheral electrolyte flow vector pointing alternately in axial sequence toward or away from the current collector 406 or the filter 414. CTP 402 contained within these flow vectors may collide with the current collector 406 surface if they penetrate the CCF 410 boundary layer, travel a short distance (about the diameter of the vortex) along the current collector surface and leave that surface. Contact with the current collector 406 surface is enhanced if the surface is substantially roughened with protuberances approximately the size of the CCF 410 boundary layer covering the surface. The protuberances will further strengthen the local vortices at the current collector 406 surface that lie outside the TVF 404.

The local vortices continuously arrive carrying charged CTP 402 and depart carrying discharged CTP 402. CTP 402 contact with the current collector 406 surface is enhanced by action of local vortices and eddies.

The CTP 300, 402 are hydrophilic and completely encased in a fluid boundary layer containing dissolved or solvated gas (fuel or oxidizer). Within that layer and adjacent the solid surfaces of the CTP 300, 402 is the IHL, of about 1 to 2-nanometer (nm) thickness, enclosed by the OHL. The IHL is intimately associated with the CTP 300, 402 crystal structure and is the locus of the EDL, which is classically defined as the location where electrons can be exchanged across it to the current collector 406 surface. The rate of exchange per unit of current collector 406 surface is the exchange current density.

Centers of ions or charged molecules that are absorbed at the surface of the CTP lie within the OHL, of about 10-nanometers thickness. It is the locus of the centers of solvated ions at their distance of closest approach to the CTP 402, 300 surfaces. Both loci are adjacent to the point of contact of CTP 300, 402 and the current collector 406 surface where charge transfer between them takes place. It is the ability of the CTP 300, 402 to compress IHL and OHL against the metal current collector 406 surface that causes charge transfer. Charge 400 transfer is virtually instantaneous once the CTP 402 makes solid contact with the current collector 406 surface. The cell's current is the integral over the current collector 406 surface of charge transfer with respect to time.

After the CTP 402 of FIG. 4 collides with the current collector 406, a proton (H⁺) ion 408 is liberated into the CCF 410 and propelled toward the filter 414 where it combines with an hydroxide (OH⁻) ion to form an H₂O molecule (not shown). Because the CCF 410 convection gradient force is so much greater that the small diffusion, concentration and migration gradient forces of conventional fuel cells, the impedance of the internal chemical circuit is dramatically reduced. A complementary scenario occurs for the oxidizer reduction reaction (ORR).

Returning to the structure of the CTP 300 of FIG. 3, capacitive anolyte particles capable of EDL charge storage can be manufactured with existing carbon technology adapted to discrete particle architecture where carbon and redox catalyst are joined as coatings of a dense metal core to form large discrete particles of 35-micron or greater enclosing sphere diameters containing finely divided (i.e., highly dispersed) catalyst material. Coatings of carbon nanotubes (CNT) or other forms of graphene with nanoscale catalyst (metals such as Pt, Ni, MnO₂ etc.) have been demonstrated (Patent Publication US 2010/0105834 of 29 APR 2010 to Tour et al). The use of CNT and graphene as supercapacitor material has also been taught (Patent Publication US 2012/0134072 of 31 May 2012 to Bac et al). However, other forms of carbon such as aerogel, activated polymer and metalloid carbides in micron-size particle form are candidates for use in galvanic cells. Current technology can decorate CNT, carbon fibers or other carbon forms on metal substrates with nano-size catalyst particles. These micron-size capacitive charge transfer particles (CCTP) have very large capacitive values due to the nature of the materials comprising them.

In one embodiment, fuel is fed as a high-temperature gas through the sub-micron to nanoscale porous, anolyte facing, surface of a negative current collector 108. The fuel is metered at a rate to meet RMS load demand—not the transient or instantaneous current. When the CCTP strikes the porous current collector, the CCTP picks up fuel in the form of solvated gas molecules that become attached to the CCTP's highly-jagged surface. If the CCTP contains a charged EDL from prior redox reactions after previous contact with the fuel rich current collector surface, then the CCTP can transfer its charge during the present contact. Charge transfer is virtually instantaneous; but, the capacitive EDL dipole charge takes longer to create.

Charge transfer from the CCTP, such as the CTP 300, to the current collector 106, 108 surface depletes the EDL charge; but, the rate of depletion depends upon several factors. External electric circuit load impedance determines the rate at which CCTP will actually transfer charge. At open circuit, there can be no transfer of charge to the current collector. Similarly, internal ionic circuit impedance will also affect charge transfer. Thus, a CCTP will be prevented from delivering a charge to the current collector 106, 108 surface if the EDL cannot simultaneously release an ion for exchange with the catholyte because, as previous explained, ionic current within a galvanic cell must balance the electric current in the external electric circuit.

When a CCTP contacts the anolyte current collector (alkaline electrolyte) and does not transfer an electron (e.g., the AC waveform is at null), it is still eligible to add charge to its EDL to the point of saturation. That process takes place as though the CCTP were a supercapacitor—even after the CCTP leaves the current collector surface to follow a recirculating path into and out of TVF.

Fuel attached to the CCTP catalyst surfaces can undergo a series of chemical reactions. Some are merely rearrangement of atoms and ions, such as dehydrogenation of methanol. These do not require electron exchange or ion release. Other steps in the reaction will move electrons and ions with respect to the carbon substrate EDL which essentially adds charge potential. Even if the chemical charging redox process is slow, it is repetitive, continuous and does not require continuous contact with the current collector 108 surface.

Given a sufficient concentration of CCTP in the anolyte there will be ample chemically-driven saturation capacity to provide high current density discharge. If demand decreases, then the CCTP will continue to charge to capacity so long as fuel is delivered. After capacity is reached additional fuel is wasted; but, the time constant is sufficiently long so that fuel throttling is practical.

A similar process occurs in the embodiment shown in FIG. 1, where oxidizer is fed through the porous current collector 106.

As previously stated, the CTP 402 must make solid contact with the current collector 406 in order to transfer charges 400. In order to attain the cell's desired current density, there must be a sufficient number of particle collisions per unit time. These two conditions cannot be attained solely with the 10-micron or smaller particles of the prior art. However, there are two alternatives that can be employed for use with the larger CTP 402.

The first option for using the 10-micron or smaller galvanic particles to create CTP 402 in a galvanic TVF cell is to mix substantially denser and larger, 100-micron-size metal particles with the micro and nano-size faradaic particles. The galvanic particles may be supported by carbon particles or carbon nanotubes. The larger, 100-micon-size particles need not be faradaic or catalytic and may comprise tungsten, alloys of stainless steel or other metals that are corrosion resistant and hydrophilic. The smaller galvanic particles will be attracted to the larger particles and held there by electrolyte surface tension and charge attraction as the larger particles are accelerated toward collisions with the current collector 406.

The second option for using the 10-micron or smaller galvanic particles to create CTP 402 is to decorate or attach (e.g., sinter, electroplate, coat, deposit) highly dispersed the 10-micron or smaller galvanic particles to the denser and larger 35 to 100-micron-size metal particles. For example, carbon nanotubes (CNT) or other forms of graphene can be grown (i.e., electroplated or vacuum oven deposited) onto tungsten, stainless steel or RANEY® nickel surfaces of 100-micron-size particles that are then coated these with galvanic fine particles. These 35 to 100-micro-size particles will have both the density and mass needed for use in TVF galvanic cells.

The second of the two options is generally preferred. Examples of depositing galvanic materials on fine particles have been described in the prior art as improvements in conventional batteries. There are descriptions of depositing catalyst onto cragged, RANEY nickel surfaces that could be used for applying faradaic materials to particles. Deposition of galvanic materials onto porous metal scaffolds used as current collectors or sintering these materials to achieve porous electrodes is common in practice. However, it is easier, less expensive and far more practical in application to deposit galvanic materials onto dispersed metal particles than to fabricate them into electrodes. Additionally, replacing particle suspensions is easier and more economical than replacing electrodes in galvanic cells.

The choice of CTP 402 used in galvanic TVF cells is aided by defining specifications for a hypothetical CTP. The CTP 402 need not be of a particular shape; but, its virtual enclosing sphere must have a diameter that is approximately one-half that of the full thickness of the nominal CCF 410 boundary layer. The CTP 402 composite density should be in a range of 2-to-6 (preferably about 4) times the mean density of their electrolyte-particle suspension. The electrically conductive core of the composite CTP 402 may occupy approximately 10% (in the range of 5 to 20%) of the CTP 402 virtual enclosing sphere. Small tungsten cores are useful because they can be fabricated to desired sizes with appropriate mean densities.

The CTP 300, 402, whether or not decorated with admetal islands 312 or catalyst particles 306, is many times the size of the catalyst particle 306 (in the range of 30 to 300 or more) and must be hydrophilic. These specifications are the consequence of calculation and experiment as briefly described below.

The following calculations are based on Eckhardt et al, Scaling of global momentum transport in Taylor-Couette and pipe flow, Eur. Phys. J. B 18, 541-544 (2000) and Eckhardt et al, Torque scaling in turbulent Taylor-Couette flow between independently rotating cylinders, J. Fluid Mech. (2007), vol. 581, 221-250 (2007). These papers and their references only describe isotropic Newtonian fluids; but, they may provide mathematical criteria for obtaining a first-order approximation of the motion of discrete particles in TVF.

Certain conserved quantities such as local angular momentum, torque as a partial time derivative of momentum and energy dissipation as a spatial integration of a torque vector can be characterized for discrete particles by applying the Rayleigh-Bénard special solution of the fundamental Navier-Stokes equations as detailed in the Eckhardt et al references. Eckhardt et al also teach how to use algebraic expressions containing the Nusselt number, Nu, and the Rayleigh number, Ra, to obtain an estimate of torque in TVF flow. The underlying analysis of TVF appears in G. I. Taylor, Stability of a Viscous Liquid contained between Two Rotating Cylinders, Phil. Trans. R. Soc. London. A 1923, Vol. 223, 289-343. Particular attention is directed at pp. 322-3 (FIGS. 4 & 5).

FIG. 5 of Taylor, p. 323, illustrates laminar streamlines defined by a parameter, n, which is related to radial velocity of fluid flow in TVF. For present purposes, these laminar streamlines can be considered cross-sections of three-dimensional cylinder-like surfaces.

When very fine particles are suspended in a liquid such as electrolyte, then the suspension forms a thixotropic, isotropic, viscid, incompressible fluid. Because the suspension is isotropic, few of the particles move across these surfaces.

The electrolytes in these surfaces also have an angular momentum, L, which is largely preserved. If torque (e.g., shear stress, friction) is not considered, then a first-order approximation of L can be calculated. The calculation can be based on an assumption that the square-like Ψₙ surface profiles are circles, without significantly affecting the estimate.

The calculation of an approximation starts with an assumption that there is a mass element, ∂m=ρ(2π)rdr where dL=υr∂m=ρ(2π)υr²dr. If dL/dr is approximately constant, then L will increase linearly with an increase in r while the product, υr², remains constant. The relationship is a reasonable fit to Taylor's stream positions for equidistant values of Ψₙ (as shown in Taylor, FIG. 5 at p. 323) computed using Table IV (Taylor at p. 322) where the peak in FIG. 4 (Taylor at p. 322) represents the tangential velocity. Then shear rate on a distinct particle, S=dυ/dr, varies as −1/r³ and βμS is a measure of shear stress on a distinct particle, where μ is local viscosity and β is a parameter that is a function of particle size and shape. Shear stress can be compared to other forces on the particle to assess its stability at a given point within the velocity vector profiles of TVF.

Because the distribution of angular momentum is over a fluid profile rather than a solid mass, the angular velocity functions, ω(r), are different for these two cases. In the case of a solid mass (e.g., a person spinning on a frictionless rotary table with weights in each hand), the value, mυr=mr²ω), is preserved in the absence of torque as weights are pulled in or out. For a fluid profile, it is the quantity, L′=mr³ω that is invariant (except for friction loss) inside a Taylor vortex.

For a cubic 3-dimensional element of fluid, it is still the quantity, L=(∂m)υr that is conserved in the absence of shear stress friction. L′ is a measure of the accumulation of angular momentum of a fluid element as a function of increasing r inside the shearing Taylor vortex fluid that controls the value of tangential velocity at position, r. Note, that a fluid element is not a solid body for which a moment of inertia about a fixed axis can be calculated. L′/R=mR²ω can represent the equivalent net L for the entire vortex where R is the vortex radius with respect to an axis about which an equivalent moment of inertia can be calculated. But, that conceals the variation of υ or ω with r, as described above. In a spinning mass where weights are pulled in, work is done against centrifugal force and kinetic energy increases. A similar condition holds inside a fluid vortex; but, the additional kinetic energy comes from a drop in pressure in accordance with Bernoulli's Principle.

Such tradeoffs between kinetic and potential energy are common in nature. For example, Keplar's model of planetary orbits varies tangential velocity as mυr=mr²ω=L=constant. In Keplar's mode, kinetic energy, Mυ²=mr²ω² increases as (L/r)² and at the expense of gravitational potential as r gets smaller. In TVF, there is an analogous exchange between kinetic and potential energy—as described next.

Fine particles in a fluid suspension (e.g., electrolyte) within TVF and away from boundary layers at walls defining a chamber are believed to follow streamline flow vectors (as shown in Taylor, FIG. 5 at p. 323) until they are expelled from the vortex. Net centrifugal force on a particle is estimated to be CF≈L′²/mr⁵ where L′ is an approximately conserved (constant) value of angular momentum, L′, and m is an expression for mass density relative to the mean density of the fluid suspension where bubbles are buoyant and have negative mass density.

For bubbles, both shear and CF act together to drive bubbles quickly to the vortex rotational axis where they become trapped until the vortex is released to the BOP through an exit port (e.g., orifices 138, 142 of FIG. 1) under axial or longitudinal flow. For particles of positive mass density, viscous and centrifugal forces are in opposition so that the particles remain within the TVF until they attain sufficient angular momentum, L′, to escape.

A metric that can be used to characterize the shear force, SF on a particle having substantial size and mass and moving with the fluid can be expressed as SF=−βμL′/mr³. The shear force is due to TVF vortex fluid shear where L′ and m are conserved quantities (constants) so the expression describes how shear force is related to distance, r from the TVF vortex axis. Shear force, SF, is always in a direction toward the vortex rotation axis, as indicated by the negative sign. β is a parameter that is related, in part, to particle size, shape and other factors. The viscosity, μ of thixotropic suspensions used here tends to diminish with increasing shear rate, S. Therefore it would normally be lowest near the vortex spin axis where S is the highest. But the latter parameter is very high (in excess of several thousand inverse seconds) everywhere in energetic TVF, so the variation of μ with r is not a significant factor.

Particle centrifugal force, CF, works to expel particles from TVF while shear force, SF, draws particles in an opposite direction toward the center of the vortex. However, the forces have different magnitudes that are functions of the distance of a particle from the center of the vortex.

Particle centrifugal force, CF, varies as L′²/mr⁵ while shear force, SF, an opposing force, varies as −αμL′/mr³. The ratio of forces, CF/SF=−αL′/μr², defines conditions when centrifugal force can overcome opposing shear pressure on the CTP as the particle approaches the vortex rotation axis (i.e., r gets smaller). While both forces vary inversely with r, under certain conditions centrifugal force can overpower shear pressure for all values of r.

Depending upon particle size and mass attributes that control the value of the CTP parameter, a, there can be values of a such that the ratio CF/SF<-1.0 for all values of r. When that occurs, there is no stable point within the vortex for such a CTP once it catches up to and enters the vortex flow field. Then, the particles near the periphery of the vortex will immediately be flung out of the vortex if there is no barrier to ejection.

Once escape occurs, the component of particle velocity vector orthogonal to the current collector surface will cause the CTP 402 to penetrate the CCF 410 boundary layer overlying the current collector 406 surface and strike that surface with sufficient force to discharge or charge the CTP 402 and to break the menisci domes 416. That is where such CTP 402 lose most or all of their angular momenta, which collectively become a torque to the system driving filter 414 rotation. The loss of momentum also causes the CTP 402 to experience a much stronger differential shear force that accelerates the CTP 402 toward the center of the vortex 404. The CTP 402 penetrates the CCF 410 boundary layer and reenters the TVF 404 to a depth sufficient to rejoin the local flow for another galvanic reaction. CTP 402 that replace the returned particle at the vortex periphery experience, in turn, the same forces so that process continues.

Charged particles suspended in galvanic cell electrolytes as taught by the prior art (e.g., teachings of Chiang et al), by themselves, cannot transfer charges effectively or at high rates. TVF galvanic cells, with their fluid dynamics systems for accelerating CTP 402 with sufficient force and frequency against current collectors 406, achieve commercially competitive current densities.

In some embodiments of this invention, individual 75-micron diameter spherical Ni or 100-micron square by 50-micron-thick stainless steel flake or smaller tungsten particles have masses of ≈4×10⁻⁶ grams, which can vary depending upon internal structural factors. This mass is fairly typical of CTP 402 suitable for use in TVF 404.

A powerful effect can be illustrated for a TVF fuel cell with a gap 118 at radius Rₒ, width in the range of 1-to-2 mm and a spin rate, Ωₒ, of 3600-RPM (377-rad./sec.). The following analysis can describe functional relationships without actually calculating the tangential velocity, υₒ at ωₒ of the outermost vortex envelope. This can be approximated using momenta and energy scaling as described in the Eckhardt et al references.

As rotation increases, CCF develops to a point where the bulk fluid becomes unstable and undergoes a transition to laminar TVF bounded by CCF boundary layers. This occurs without a discontinuity in the energy being applied to the system. As a consequence, pressure on the walls containing the flow will not change. An element of fluid with mass of ∂m, near the moving surface and rotating about the cell's spin axis becomes an element at the periphery of a TVF vortex rotating about a TVF axis circling the cell's axis (see Case A, FIG. 2D). The mass ∂m does this without a change in kinetic energy or pressure within the fluid. Therefore, ∂m(rₒωₒ)²=∂m(RₒΩₒ)² and ωₒ=Ωₒ(Rₒ/rₒ) where rₒ is the peripheral radius of the vortex and rₒωₒ its peripheral tangential velocity. The same applies to Rₒ and ΩₒL. This fundamental continuity equation becomes a point of reference for the velocity profile calculated by Taylor for Ψₙ.

In one embodiment, the filter diameter may be 30-mm and the TVF gap may be in the range of 1 to 2-mm. The filter surface speed is 565.5-cm/sec. at 3600-RPM, which is the speed of a 60-Hz alternating current synchronous motor. That is also the peripheral tangential velocity of the vortex regardless of gap width. However, the Ψₒ spin rate becomes 1,800-Hz for a 1-mm gap or 900-Hz for a 2-mm gap. Particles entrained within this flow at the vortex periphery and moving at its velocity will be ejected from the vortex and impact the current collector with considerable force that depends upon how much of the particle momentum is lost upon each impact. The force, if all the momentum is lost at the first impact, is limited by an impulse, J=∫ₜ_{₁}^{t}^{₂}mdv=∫ₜ_{₁}^{t}^{₂}Fdt,=F_{avg}(t₂−t₁). Since the mass of a typical CTP for suspensions used here is approximately 4 micro-grams, the prospective maximum impulse is 2.26×10⁻³-gm-cm/sec.

A CTP will travel during the interval (t₂−t₁) a distance that is estimated to be approximately the center distance between protuberances on the metal current collector, which is about 50-microns. If the CTP velocity is greater than 500 cm/sec., then the impact interval at first or subsequent strikes would have to be less than 10⁻⁵ seconds. There is sufficient impact force to penetrate the Helmholtz planes and any solid-electrolyte interface (SEI) surface deposits.

The TVF gaps and rotational velocities used in this invention are extremely energetic compared to the multi-cm gaps and low RPM commonly found in prior art fuel cells. These differences contribute to the high current, power and energy densities of fuel cells taught here.

Charging of a fuel cell CTP 300, 402 is equivalent to catalyzed redox (oxygen to the cathode and fuel to the anode) charging of a fuel cell with no load or overvoltage at its exchange current density, jₒ. It also includes charging an EDL, as in a supercapacitor.

Fuel cell catalysis is optimized when it proceeds continuously at the typically low exchange current density, ≈jₒ, with respect to specific catalyst surface area. The maximum load should be only a very little more than jₒ. Transient increases should be met with current drawn from the EDL. During periods of lower load demand, jₒ can continue to charge the EDL to full capacity. That will permit a smoother adjustment of stoichiometric gas supply. Because charge transfer to and from the EDL is fast, the EDL associated with the CTP 300, 402 supports much higher fuel cell efficiency.

Where the CTP 300, 402 comprise catalyst particles supported on carbon, which emulates an EDL of a supercapacitor, the amount of charge carried by the EDL can be greatly increased if the carbon is finely divided (e.g., graphene, CNT), as in the supercapacitor. A fuel cell CTP 300, 402 built around a dense core coated with finely divided carbon is preferred because it significantly increases the surface area for storage of charge held by a polarized EDL. That charge is fed by an exchange current density, jₒ, to the limit of the fuel cell's Gibbs free energy, zero-current potential, Vₑ.

The basic electrochemistry of the fuel cell is derived from the Gibbs Function and the Arrhenius equation and can be summarized as follows:

V=Vₑ−Vₒ−(RT/2αF)ln(j/jₒ)

where:

V=net fuel cell voltage;

Vₒ=an activation overvoltage that tends to 0 with temperatures above 250° C.;

T=temperature in ° K;

R=universal gas constant;

F=Faraday constant;

α=charge transfer coefficient (usually about 0.5 at 60° C.);

j=current density; and

jₒ=exchange current density

When T increases from 300° K to 600° K (about 323° C. and much higher than the 160° C. limit for NAFION PEM cells), then the value of a approaches 1.0 and the influence of elevated temperature on the coefficient or multiplier of the logarithm (i.e., Tafel slope) becomes negligible because jₒ markedly increases with an increase in temperature.

Fuel cells should be sized to operate so that the maximum catalyst-specific supply current, j, is as close to jₒ as possible so that the operating voltage V is as close to Vₑ as possible. Typical values of V, for many fuels (e.g., hydrogen, methane, methanol, gasoline and kerosene) are in the range of 1.0 to 1.2 volts. This voltage is a safe potential for storing charge in an EDL using carbon.

Values of jₒ can vary by orders of magnitude among catalysts, temperatures and fuel and oxidizer chemistries. Fast reactions at low temperatures (≈60° C.) are limited almost exclusively to hydrogen fuel on platinum catalyst and yield electrode current densities that are substantially less than 1.0 A/cm². Above 250° C. and when gas molecular mass transport and solvation is substantially accelerated as earlier described, Ni is nearly as active as the noble metals for fuel oxidation and NiO or MnO₂ are equally active for the ORR.

Published values of jₒ represent the collective result of many rate-limiting effects. These include the mass transport of constituents to and from the catalyst surface, the rate of the chemical reaction and the fraction of catalyst surface in a given fuel cell architecture that can actually participate in the redox reaction. Therefore, three goals are to 1) increase the mass transport flux of reactants arriving and leaving catalyst surfaces, 2) increase the number of catalyst particles and amount of participating catalyst surface of the CTP 300, 402 and the number of CTP 300, 402 serving a unit area of current collector and 3) store an efficient and continuous production of charge from the catalyst onto capacitive EDL surfaces of the CTP 300, 402 so that rapid charge transfer can occur at the current collector surface. TVF 144, 146 address the first of these goals while CTP 300, 402 taught here address both the second and the third of these goals of increasing the total current produced by a single CTP 300, 402.

Each of the millions to billions of catalyst particles on a CTP 300, 402 adds charge to the CTP's EDL. Each of the millions to billions of CTPs colliding with and transferring charge to the current collector 106, 108, 406 represents a parallel addition of jₒ to the cell's overall current density and a corresponding reduction in functional internal impedance of the cell.

Chemical reactions on catalyst surfaces release both ions and reaction products (e.g., H₂O, CO₂) and thrust them into the electrolyte. Unlike the conventional fuel cells where only small forces are available to accelerate ions to low velocities, the TVF fuel cells 102 utilize CCF 148, 150 and TVF 144, 146 to achieve high ion velocities. The TVF 144, 146 also sweep reaction products (primarily gases) away from the catalyst surfaces into vortex centers so that fresh fuel or oxygen-saturated electrolyte can replace them near the current collector 106, 108, 406 surfaces. This is especially important when hydrocarbon fuels (e.g., methane, methanol, ethanol) create CO and other reaction products that can poison catalysts. TVF capture the reaction products and move them to the BOP, where they can be exhausted or recycled.

Current density is not limited to the SA of conventional static catalyst contained within a narrow band of porous electrode surface adjacent the electrolyte. In a TVF fuel cell 102 with the CTP 300, 402 taught here, there is a much higher concentration of catalyst surface available to a unit area or cm² of current collector 106, 108, 406 surface than for a conventional cell's electrode. Current density is a function of the frequency of CTP 300, 402 impacts with the current collector. For TVF cells 102 with the CTP 300, 402 taught here, the current density at the current collectors 106, 108, 406 is several orders of magnitude higher that the current density of electrodes in conventional fuel cells. The CTP 300, 402 taught here eliminate any need for temperature-sensitive membrane electrode assemblies and facilitate higher temperatures that permit use of much less expensive catalysts while achieving still higher current density.

In conventional cells where catalyst particles are fixed within electrode pores, electrons are generated and exchanged by each catalyst particle after fuel or oxygen gas transits the pores and diffuses through electrolyte to reach the catalyst surface. Then, a redox reaction takes place on the catalyst surfaces that causes both ion diffusion and production of redox reaction intermediate products within the pores.

Both the diffusion and the redox processes require substantial time intervals for completion. For example, the ORR and most fuel gasses require several intermediate steps to produce intermediate products that delay the overall reaction. Because the redox reactions take place within narrow confines of pores, the reactions must slow to a pace where the pores are purged of the reaction products by the entry of fresh gases.

By contrast, the TVF cell dynamic catalyst suspension carries 3 or 4-orders of magnitude more catalyst surface area servicing the projected area of a current collector equal to surface area of a conventional electrode. For example, a 1-mm TVF suspension gap is 30 to 40-times thicker than the conventional 30-μm thick porous electrode (where thickness is measured by penetration of electrolyte) and the TVF fuel cell 102 catalyst concentration is 30 to 40% instead of 0.2 to 0.3% by volume for the conventional fuel cell. The combination of these two features favor the TVF fuel cell 102 by a factor of 3000 to 4000.

The TVF fuel cell 102 advantage is further enhanced by the treatment of catalyst. In the conventional cells, catalyst is fixed in place within narrow pores of the electrodes. In TVF fuel cells 102, virtually the entire area of each current collector 106, 108, 406 surface is continuously bombarded by CTP 300, 402 which discharges accumulated EDL capacity. As described above, the charge in the EDL is being continuously replenished by a large amount of finely divided nanoscale catalyst particles covering and contained within the CTP 300, 402 structure. A CTP 300, 402 remains in contact with the current collector 106, 108, 406 only briefly; but, EDL charge transfer is very rapid. Once a given CTP 300, 402 rebounds from the current collector 106, 108, 406 surface, it is quickly replaced by another CTP that will repeat the process.

In contrast to conventional cells, the TVF cells do not have to wait for a single catalyst particle to process its gas. An enormous number of CTPs fully cover the TVF cell current collector surfaces where the CTPs simultaneously are attracting a fresh supply of gas from the current collector and exchanging charge with the current collector. In both cases, CTP time at the current collector surface is only a few microseconds so there is no CTP congestion. Thus, there is a much higher complement of catalyst available in TVF cells than in conventional cells. A higher complement of catalyst is responsible for higher current density.

### SUMMARY

In one embodiment, a fuel cell (102) containing a flowable electrolyte suspension comprising electrolyte; and particles (300, 402) including galvanic material that are entrained in the electrolyte.

In a second embodiment, a fuel cell (102) containing a flowable electrolyte suspension wherein the electrolyte suspension is thixotropic.

In a third embodiment, a fuel cell (102) wherein particles (300, 402) entrained in electrolyte have a diameter of at least 30-microns.

In a fourth embodiment, a fuel cell (102) wherein particles (300, 402) entrained in electrolyte have a mass of at least 0.5×10⁻⁶ grams.

In a fifth embodiment, a fuel cell (102) wherein the particles (300, 402) entrained in electrolyte have a composite density in a range of 2-to-6 times the mean density of their electrolyte-particle suspension.

In a sixth embodiment, a fuel cell (102) wherein particles (300, 402) are decorated with catalytic particles (306).

In a seventh embodiment, a fuel cell (102) wherein catalytic particles (306) entrained in electrolyte are attached to a skin (304) of electrically-conducting material covering a metal core (302) to form a charge transfer particle (300).

In an eighth embodiment, a fuel cell (102) wherein catalytic particles (306) are attached to a skin (304) of electrically-conducting material that is carbon.

In a ninth embodiment, a fuel cell (102) wherein catalytic particles (306) are attached to a skin (304) of electrically-conducting material that are decorated with nanoscale catalyst particles (306).

In a tenth embodiment, a fuel cell (102) wherein catalytic particles (306) are attached to a skin (304) of electrically-conducting material that are decorated with nanoscale catalyst particles (306) of a metal selected from a set containing NiOOH, Ni, MnO₂ and a metal containing an element selected from Group 10 of the Periodic Table of the Elements.

In an eleventh embodiment, a fuel cell (102) wherein catalytic particles (306) entrained in electrolyte are attached to a skin (304) of electrically-conducting material covering a metal core (302) to form a charge transfer particle (300) and the core (302) is a metal having a density of at least 8 grams per cm⁻³.

In a twelfth embodiment, a fuel cell (102) wherein catalytic particles (306) have a core (310) of a first metal that supports islands (312) created by depositing a second metal in a process that displaces surface atoms of the first metal.

In a thirteenth embodiment, a fuel cell (102) containing an electrolyte suspension of catalytic particles (306) having cores (310) of a first metal that supports islands (312) created by depositing a second metal in a process that displaces surface atoms of the first metal wherein one of the metals contains an element selected from Group 10 of the Periodic Table of the Elements.

In a fourteenth embodiment, a fuel cell (102) comprising in addition means for creating Taylor Vortex Flows (144, 146) in its electrolyte containing entrained galvanic material.

In a fifteenth embodiment, a fuel cell (102) comprising in addition means for creating Circular Couette Flows (148, 150) in its electrolyte containing entrained galvanic material.

In a sixteenth embodiment, a fuel cell (102) comprising first and second current collectors (106, 108) separated by a gap (118); a filter (120) within the gap (118) and dividing the gap (118) into an outer electrolyte chamber (122) containing electrolyte and an inner electrolyte chamber (124) containing electrolyte; and means for moving the filter (120) within the gap (118) to generate electrolyte Taylor Vortex Flows (144, 146) in at least one of the electrolyte chambers (122, 124).

In a seventeenth embodiment, a fuel cell (102) comprising in addition first and second current collectors (106, 108) separated by a gap (118); a filter (120) within the gap (118) and dividing the gap (118) into an outer electrolyte chamber (122) containing electrolyte and an inner electrolyte chamber (124) containing electrolyte; and means for moving the filter (120) within the gap (118) to generate electrolyte Circular Couette Flows (148, 150) in at least one of the electrolyte chambers (122, 124).

In a eighteenth embodiment, a fuel cell (102) containing first and second current collectors (106, 108) wherein at least one of the current collectors (106, 108) is porous.

In a nineteenth embodiment, a fuel cell (102) containing first and second electrolyte chambers (122, 124) each having a porous current collector (106, 108); means for pumping a fluid selected from a set consisting fuel and oxidizer through one of the porous current collectors (106, 108) toward one of the electrolyte chambers (122, 124).

In a twentieth embodiment, a fuel cell (102) comprising a porous current collector with an electrolyte-facing surface and containing addition means for regulating temperature and pressure of a fluid to convert it into a gas that can create an external electrolyte meniscus dome (212) in electrolyte outside of the electrolyte facing surface of a porous current collector (106, 108).

In a twenty-first embodiment, a fuel cell (102) comprising current collectors (106, 108) decorated with galvanic flakes.

In twenty-second embodiment, a fuel cell (102) containing a current collector (106, 108) that is a composite containing a galvanic material coating (518).

In a twenty-third embodiment, a fuel cell (102) comprising two electrode chambers (122, 124) separated by a filter (120) that is permeable to flow of electrolyte in the electrolyte chambers (122, 124); but, not particles (300, 402) entrained in the electrolyte.

In a twenty-fourth embodiment, a fuel cell (102) comprising means for rotating a filter (120) between two electrolyte chambers (122, 124) to create a vortex (144, 146, 404) in the electrolyte of one of the electrolyte chambers (122, 124).

### CONCLUSION

The galvanic fuel cells of this invention offer structures that provide improved fluid dynamics (e.g., TVF, CCF) for use with flowable electrolyte suspensions that contain galvanic charge transfer particles acting as electrodes in coordination with current collectors that need not contain galvanic materials. Unlike prior art fuel cells where galvanic particles are sparsely secured in fixed positions to electrodes and difficult to replace, the charge transfer particles in the fuel cells of this invention are plentiful and can be easily replaced by simply replacing the electrolyte suspension. These differences—amongst others—provide more economical fuel cells with higher current densities.

All patents and patent applications identified in this disclosure are hereby incorporated herein by reference.

While the present disclosure has been presented above with respect to the described and illustrated embodiments using TVF and CCF, it is to be understood that the disclosure is not to be limited to those alternatives and described embodiments. Accordingly, reference should be made primarily to the following claims to determine the scope of my invention.

I claim:

1. A fuel cell (102) containing a flowable electrolyte suspension comprising:
electrolyte; and
particles (300, 402) including a galvanic material that are entrained in the electrolyte.

2. The fuel cell (102) of claim 1 wherein the electrolyte suspension is:
thixotropic.

3. The fuel cell (102) of claim 1 wherein the particles (300, 402) have:
a diameter of at least 30-microns.

4. The fuel cell (102) of claim 1 wherein the particles (300, 402) have:
a mass of at least 0.5×10⁻⁶ grams.

5. The fuel cell (102) of claim 1 wherein the particles (300, 402) have:
a composite density in a range of 2-to-6 times the mean density of their electrolyte-particle suspension.

6. The fuel cell (102) of claim 1 wherein the particles (300, 402) are decorated with:
catalytic particles (306).

7. The fuel cell (102) of claim 6 wherein:
the catalytic particles (306) are attached to a skin (304) of electrically-conducting material covering a metal core (302) to form a charge transfer particle (300).

8. The fuel cell (102) of claim 7 wherein:
the electrically-conducting material is carbon.

9. The fuel cell (102) of claim 8 wherein:
the skin (304) of carbon electrically-conducting material is decorated with nanoscale catalyst particles (306).

10. The fuel cell (102) of claim 9 wherein;
the catalyst particles are nanoscale deposits of a metal selected from a set containing NiOOH, Ni, MnO₂ and a metal containing an element selected from Group 10 of the Periodic Table of the Elements.

11. The fuel cell (102) of claim 7 wherein;
the core (302) is a metal having a density of at least 8 grams per cm⁻³.

12. The fuel cell (102) of claim 6 wherein:
the catalytic particles (306) have a core (310) of a first metal that supports islands (312) created by depositing a second metal in a process that displaces surface atoms of the first metal.

13. The fuel cell (102) of claim 12 wherein:
one of the metals contains an element selected from Group 10 of the Periodic Table of the Elements.

14. The fuel cell (102) of claim 1, comprising in addition:
means for creating Taylor Vortex Flows (144, 146) in the electrolyte.

15. The fuel cell (102) of claim 1, comprising in addition:
means for creating Circular Couette Flows (148, 150) in the electrolyte.

16. The fuel cell (102) of claim 1, comprising in addition:
a. first and second current collectors (106, 108) separated by a gap (118);
b. a filter (120) within the gap (118) and dividing the gap (118) into an outer electrolyte chamber (122) and an inner electrolyte chamber (124);
c. electrolyte in at least one of the electrolyte chambers (122, 124); and
d. means for moving the filter (120) within the gap (118) to generate Taylor Vortex Flows (144, 146) in the electrolyte in at least one of the electrolyte chambers (122, 124).

17. The fuel cell (102) of claim 16, comprising in addition:
means for moving the filter (120) within the gap (118) to generate Circular Couette Flows (148, 150) in the electrolyte in at least one of the electrolyte chambers (122, 124).

18. The fuel cell (102) of claim 16, wherein:
at least one of the current collectors (106, 108) is porous.

19. The fuel cell (102) of claim 18, comprising in addition:
means for pumping a fluid selected from a set consisting fuel and oxidizer through one of the porous current collectors (106, 108) toward one of the electrolyte chambers (122, 124).

20. The fuel cell (102) of claim 19, comprising in addition:
means for regulating temperature and pressure of the fluid to convert it into a gas that can create an external electrolyte meniscus gas dome (212) in the electrolyte outside of the electrolyte-facing surface of the porous current collector (106, 108).

21. The fuel cell (102) of claim 16 where:
one of the current collectors (106, 108) is decorated with galvanic flakes.

22. The fuel cell (102) of claim 16 wherein:
one of the current collectors (106, 108) is a composite that contains a galvanic material coating (518).

23. The fuel cell (102) of claim 1 comprising in addition:
two electrolyte chambers (122, 124) separated by a filter (120) that is permeable to flow of the electrolyte in the electrolyte chambers (122, 124);
but, not the particles (300, 402) entrained in the electrolyte.

24. The fuel cell (102) of claim 23 comprising in addition:
means for rotating the filter (120) to create a vortex (144, 146, 404) in the electrolyte in one of the electrolyte chambers (122, 124).
